(19) United States
(12) Patent Application Publication
(10) Pub. No.: US 2021/0114032 A1
(43) Pub. Date: Apr. 22, 2021

(54) FLUIDIC DIES

(71) Applicant: HEWLETT-PACKARD DEVELOPMENT COMPANY, L.P., Spring, TX (US)

(72) Inventors: Garrett E. Clark, Corvallis, OR (US); Si-lam Choy, Corvallis, OR (US); Jacob Lum, Corvallis, OR (US); Craig Olbrich, Corvallis, OR (US); Jeremy Sells, Corvallis, OR (US); Tsuyoshi Yamashita, Corvallis, OR (US)

(73) Assignee: HEWLETT-PACKARD DEVELOPMENT COMPANY, L.P., Spring, TX (US)

(21) Appl. No.: 17/044,404

(22) PCT Filed: Apr. 23, 2018
(86) PCT No.: PCT/US2018/028873

§ 371 Date: Oct. 1, 2020

(51) Int. Cl. B01L 3/00

(52) U.S. Cl. CPC B01L 3/502776; B33Y 30/00; B01L 3/502784

(57) ABSTRACT

A fluidic die may include a at least one actuator, and fluid flow architecture to flow a first fluid through at least one fluidic channel, and flow a second fluid through the at least one fluidic channel to form a laminar flow between the first fluid and the actuator. The at least one actuator forms a drive bubble from the second fluid to cause the first fluid to be ejected from the fluidic die.

### BACKGROUND

A fluidic die or similar device may be used to move fluids within the fluidic die, eject fluids onto media, or combinations thereof. The fluids within a fluidic device such as, for example, a fluidic die may include any fluid that may be moved within or ejected from the fluidic device. For example, the fluids may include inks, dyes, chemical pharmaceuticals, biological fluids, gases, and other fluids. The fluids may be used to print images on media or effectuate chemical reactions between different fluids such as in lab-on-chip devices, for example. Further, in additive manufacturing processes such as those that use a three-dimensional (3D) printing device, the fluidic die may eject build materials, adhesives, and other fluids that may be used to build a 3D object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a side, cutaway view of a, block diagram of a fluidic device, according to an example of the principles described herein.

FIG. 2 is a side, cutaway view of a, block diagram of a dual-fluid ejection system, according to an example of the principles described herein.

FIG. 3 is a side, cutaway view of a, block diagram of a fluidic device at an initial state before fluid ejection, according to an example of the principles described herein.

FIG. 4 is a side, cutaway view of a, block diagram of the fluidic device of FIG. 3 at an ejection state, according to an example of the principles described herein.

FIG. 5 is a top, cutaway view of a block diagram of a fluidic device, according to an example of the principles described herein.

FIG. 6 is a top, cutaway view of a block diagram of a fluidic device, according to an example of the principles described herein.

FIG. 7 is a top, cutaway view of a block diagram of a fluidic device, according to an example of the principles described herein.

FIG. 8 is a top, cutaway view of a block diagram of a fluidic device, according to an example of the principles described herein.

FIG. 9 is a top, cutaway view of a block diagram of a fluidic device, according to an example of the principles described herein.

FIG. 10 is a side, cutaway view of a, block diagram of a fluidic device, according to an example of the principles described herein.

FIG. 11 is a top, cutaway view of a block diagram of a fluidic device, according to an example of the principles described herein.

FIG. 12 is a first side, cutaway view of a block diagram of the fluidic device of FIG. 11, according to an example of the principles described herein.

FIG. 13 is a second side, cutaway view of a block diagram of the fluidic device of FIG. 11, according to an example of the principles described herein.

FIG. 14 is a side, cutaway view of a block diagram of a fluidic device including two nozzles, according to an example of the principles described herein.

FIG. 15 is a side, cutaway view of a block diagram of a fluidic device including two nozzles, according to an example of the principles described herein.

FIG. 16 is a side, cutaway view of a block diagram of the fluidic device of FIG. 15 at an initial state of ejection, according to an example of the principles described herein.

FIG. 17 is a side, cutaway view of a block diagram of the fluidic device of FIG. 15 at a subsequent state of ejection, according to an example of the principles described herein.

FIG. 18 is a side, cutaway view of a block diagram of the fluidic device of FIG. 15 at a subsequent state of ejection, according to an example of the principles described herein.

FIG. 19 is a side, cutaway view of a block diagram of the fluidic device of FIG. 15 at a subsequent state of ejection, according to an example of the principles described herein.

FIG. 20 is a side, cutaway view of a block diagram of the fluidic device of FIG. 15 at a subsequent state of ejection, according to an example of the principles described herein.

FIG. 21 is a top, cutaway view of a block diagram of fluidic feed channels of the fluidic devices of FIGS. 11 through 20, according to an example of the principles described herein.

FIG. 22 is a side, cutaway view of a block diagram of a fluidic device, according to an example of the principles described herein.

FIG. 23 is a side, cutaway view of a block diagram of a fluidic device, according to an example of the principles described herein.

FIG. 24 is a top, cutaway view of a block diagram of a fluidic device, according to an example of the principles described herein.

FIG. 25 is a top, cutaway view of a block diagram of a fluidic device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, a fluidic device such as, for example. a fluidic die may include a first fluid that may be purged from the fluidic device or to another fluidic passageway within the fluidic device. In some fluidic devices, the first fluid is ejected from or moved within the fluidic device by forming a drive bubble through the activation of a thermal heating devices such as a thermal resistor. These thermal heating devices are used to form a drive bubble of vaporized fluid separated from liquid fluid by a bubble wall. The drive bubble forces the fluid from the fluid ejection chamber and out the nozzle. Once the drive bubble collapses, additional fluid from a reservoir may flow into the fluid passageways including fluid channels, and fluid ejection chambers, replenishing the lost fluid volume from the creation of the drive bubble and the ejection of the fluid. This process may be repeated each time the fluidic device is instructed to eject fluid.

In some examples, the fluid within the fluidic device may react with or otherwise be incompatible with the thermal resistors. Thus, in some examples, the fluid may be designed to avoid damage to the thermal resistors or contamination of the thermal resistors. This may limit types and formulations of fluids that may be ejected from or moved within the fluidic device.

Thus, in the examples described herein, the fluidic devices may employ two separate and different fluids to eject a first one of the fluids from the fluidic device through the formation of a drive bubble from the second one of the fluids. The first fluid may be referred to as an ejection fluid, and the second fluid may be referred to as a drive fluid. The first fluid acting as the ejection fluid is that fluid that is ultimately ejected from the fluidic device or into other passageways within the fluidic device. The second fluid acting as the drive fluid is the fluid from which the drive bubble is formed. This drive bubble formed from the second fluid is then used to move or eject the first fluid.

In this manner, the chemical formulation of the drive fluid may be optimized for resistor interactions to ensure that any damage to the thermal resistors or contamination of the thermal resistors does not occur. Further, the first fluid acting as the ejection fluid may be optimized for other factors such as durability, color gamut, or other desirable print qualities in a printed fluid or when the fluid is used for printing. When the fluid is used for chemical or biological analysis within the fluidic device, the first fluid may be optimized to allow for more flexible and pure reactions and interactions with other fluids. Overall, the examples described herein allow for more flexible types and formulations of fluids, provide for a longer fluidic device and printhead life, and provides for less expensive fluidic devices to both the manufacturer and the end purchaser and user.

Examples described herein provide a fluidic device. The fluidic device may include a first fluid, a second fluid different from the first fluid, and an actuator to form a drive bubble from the second fluid to cause the first fluid to be ejected from the fluidic device. The fluidic device may include architecture to cause the second fluid to form a laminar flow between the first fluid and the actuator.

The first fluid and the second fluid may be non-aqueous and aqueous respectively, aqueous and non-aqueous respectively, both aqueous, both non-aqueous, a non-polar solvent and a polar solvent respectively, a polar solvent and non-polar solvent respectively, miscible, immiscible, a suspension, an emulsion, or combinations thereof. The fluidic device may include a pump to cause the flow rate of the first fluid to be greater than the flow rate of the second fluid.

The fluidic device may include a first fluidic channel in which the first fluid flows and a second fluidic channel in which the second fluid flows. A cross-sectional area of the second fluidic channel may be narrower than a cross-sectional area of the first fluidic channel. The fluidic device may include at least one permeable flow separator between the first fluidic channel and the second fluidic channel. At least one opening in the permeable flow separator may comprise a cross-sectional area that is narrower than the first fluidic channel and the second fluidic channel. The at least one permeable flow separator may reduce mixing between the first fluid and the second fluid.

The fluidic device may include a first fluidic channel in which the first fluid flows. The first fluidic channel includes a first nozzle defined therein, and a second fluidic channel in which the second fluid flows, the second fluidic channel comprising a second nozzle defined therein and fluidically coupled to the first fluidic channel. The actuator may be off-axis relative to a center of a nozzle from which the first fluid is ejected.

Examples described herein may also provide a dual-fluid ejection system. The dual fluid ejection system may include a first fluid, and a second fluid different from the first fluid. The second fluid may include at least one chemical property for drive bubble creation by an actuator. The dual-fluid ejection system may include a first pump to cause the first fluid to flow in a first portion of the ejection system, and a second pump to cause the second fluid to flow in a second portion of the ejection system between the flow of the first fluid and the actuator.

The ejection system may also include at least actuator. The position of the at least one actuator within the ejection system defines a level of mixture of the first fluid and the second fluid. The ejection system may include a controller to activate the first pump to cause the first fluid to flow at a first flow rate, and activate the second pump to cause the second fluid to flow at a second flow rate. The first flow rate may be greater than the second flow rate. The second fluid may balance the evaporative loss of volatile components of the first fluid, the second fluid may be an activating agent with respect to the first fluid that changes at least one property of the first fluid, includes an immiscible combination that is separated after removal from the ejection system, or combinations thereof.

Examples described herein may also provide a method of ejecting fluid from a fluidic device. The method may include flowing a first fluid through a first fluidic channel, flowing a second fluid different from the first fluid between the first fluid and an actuator, and activating the actuator to form a drive bubble from the second fluid to cause the first fluid to be ejected from the fluidic device. Flowing the first fluid and the second fluid may include flowing the second fluid in a laminar flow between the first fluid and the actuator.

The method may include, with a first pump, pumping the first fluid at a first flow rate, and with a second pump, pumping the second fluid at a second flow rate. The first flow rate may be greater than the second flow rate. Activating the actuator to form a drive bubble from the second fluid causes the first fluid to be ejected from the fluidic device and may include ejecting the second fluid through a second nozzle defined in the second fluidic channel based on an actuation of the actuator, and ejecting the first fluid through a first nozzle defined in the first fluidic channel based on the drive bubble formed by the activation of the actuator.

As used in the present specification and in the appended claims, the term “fluidic device” is meant to be understood broadly as any device that ejects fluids or moves fluids within itself. These fluidic devices may include, for example, fluidic dies, lab-on-chip devices, and additive manufacturing dies, among other fluidic devices.

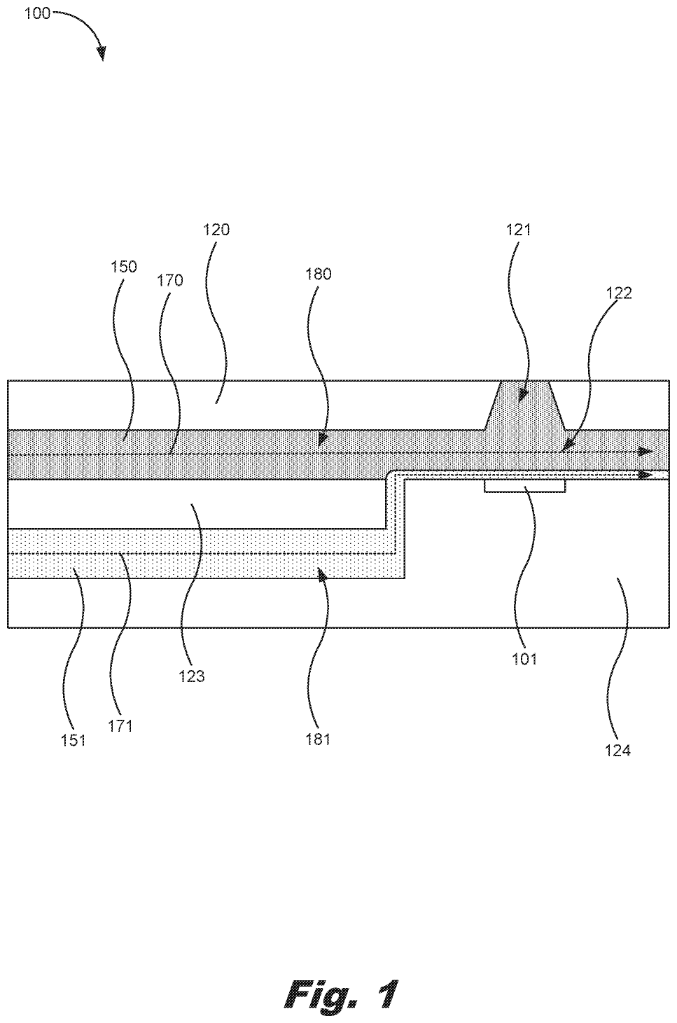

Turning now to the figures, FIG. 1 is a side, cutaway view of a, block diagram of a fluidic device (100), according to an example of the principles described herein. The fluidic device (100) of FIG. 1 utilizes a laminar flow of a first fluid (150) over a second fluid (151) with an actuator (101) located on the side of the laminar flow of the second fluid (151) opposite the side on which the first fluid (150) is located. The dashed arrows (170, 171) of FIG. 1 indicate the flow of the first fluid (150) and the second fluid (151), respectively.

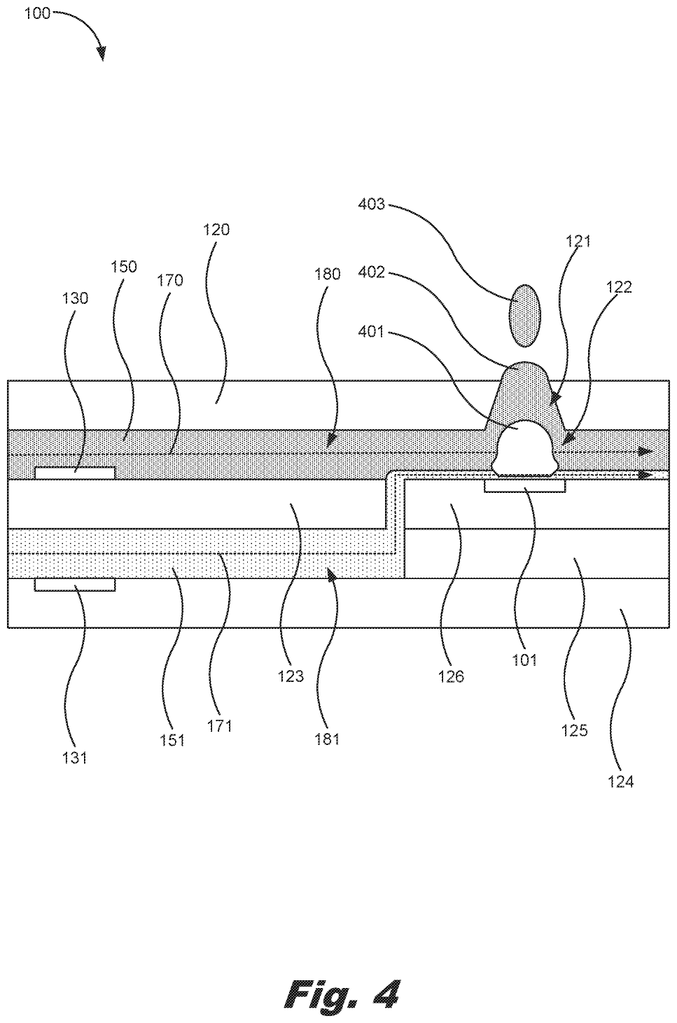

The actuator (101) within FIG. 1 and throughout the figures described herein may be any device that may utilize the second fluid (151) to move the first fluid (150). In an example, the actuator (101) may be a thermal resistive device that forms a drive bubble of vaporized fluid from the second fluid (151) and separated from liquid fluid by a bubble wall. In another example, the actuator (101) may be a mechanical actuator that moves the fluid. In still another example, the actuator may be piezoelectric actuators that generate a pressure pulse that moves a volume of the fluid (150, 151). In this example, the piezoelectric actuators may include a piezoelectric material that has a polarization orientation that provides a motion into the fluid ejection chambers (122) when and electrical charge is applied to the piezoelectric material. The actuator (100) forms a drive bubble (FIG. 4, 401) from the second fluid (151) to cause the first fluid (150) to be ejected from the fluidic device (100).

The first fluid (150) may be fed into the fluid ejection chamber (122) via a first fluid channel (180). Similarly, the second fluid (151) may be fed into the fluid ejection chamber (122) via a second fluid channel (181). In an example, the second fluid channel (181) may be fluidically coupled to the first fluid channel (180) just before the fluids (150, 151) are introduced into the fluid ejection chamber (122).

The fluidic device (100) may also include a number of layers (120, 123, 124). For example, the fluidic device (100) may include a substrate layer (124) to support the fluidic device (100), an intermediate layer (123) to introduce the two fluids (150, 151) into a fluid ejection chamber (122), and a nozzle layer (120) with a nozzle (121) defined therein to allow the first fluid (150) to be ejected from the fluidic device (100). Although throughout the figures described herein, the fluidic device is depicted as being a fluid ejection device such as, for example, a printhead, the fluidic device (100) may be any device that ejects fluid from or moves fluid within the fluidic device (100) including, for example, a lab-on-chip device. Throughout the examples herein, two fluids (150, 151) are described as functioning to eject one of the two fluids from the fluidic devices (100). However, at least two fluids may be used to eject at least one fluid from the fluidic devices (100). For example, three fluids may be used where two fluids are ejected from the fluidic device (100) and a third is used as the drive fluid much as the second fluid (151) is described herein as function as.

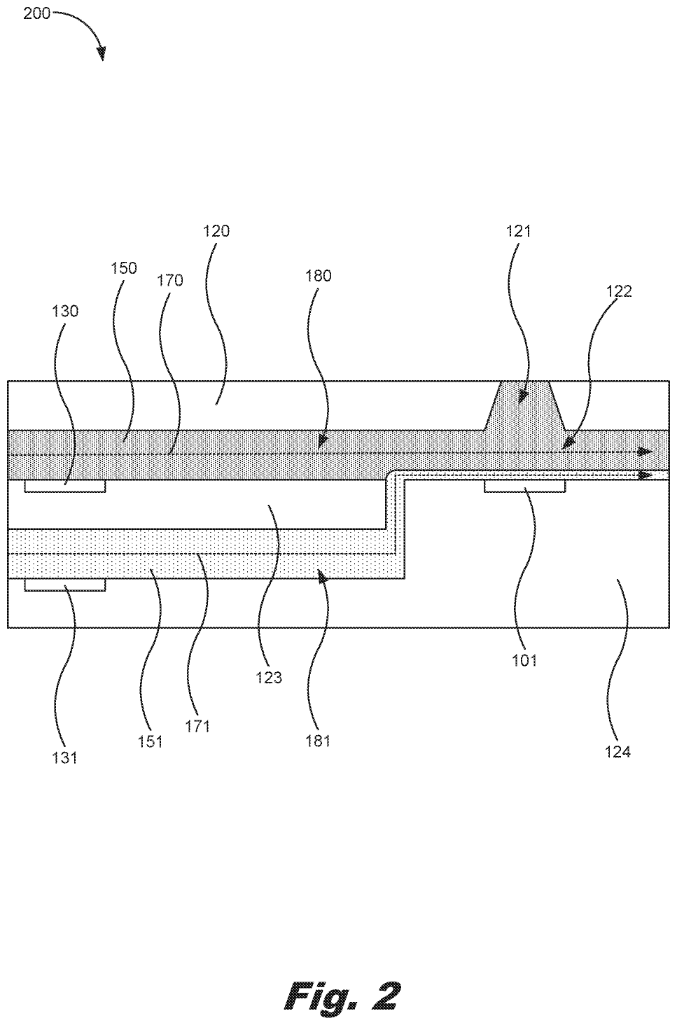

FIG. 2 is a side, cutaway view of a, block diagram of a dual-fluid ejection system (200), according to an example of the principles described herein. The system (200) may include those elements described above in connection with the fluidic device (100) described herein in connection with FIG. 1 and elsewhere. Further, the system (200) may also include pumps (130, 131) that assist in pumping the fluids (150, 151) through their respective fluid channels (180, 181) and into the fluid ejection chamber (122). The pumps (130, 131) may cause the fluids (150, 151) to flow at different rates to ensure that a laminar flow of the second fluid (151) is maintained between the flow of the first fluid (150) and the actuator (101). The pumps (130, 131) may include inertial pumps that include thermal resistive elements like the actuators (101), or the pumps (130, 131) may include external pump devices that are fluidically coupled to the fluidic devices and systems (100, 200, 300) to move the fluids through the fluidic devices and systems (100, 200, 300).

Even though some examples described herein include the pumps (130, 131), other devices, architectures, and methods may be used to generate pressures within the fluidic devices and systems (100, 200, 300). For example, capillary forces and gravity may be used to generate pressure within the fluidic devices and systems (100, 200, 300).

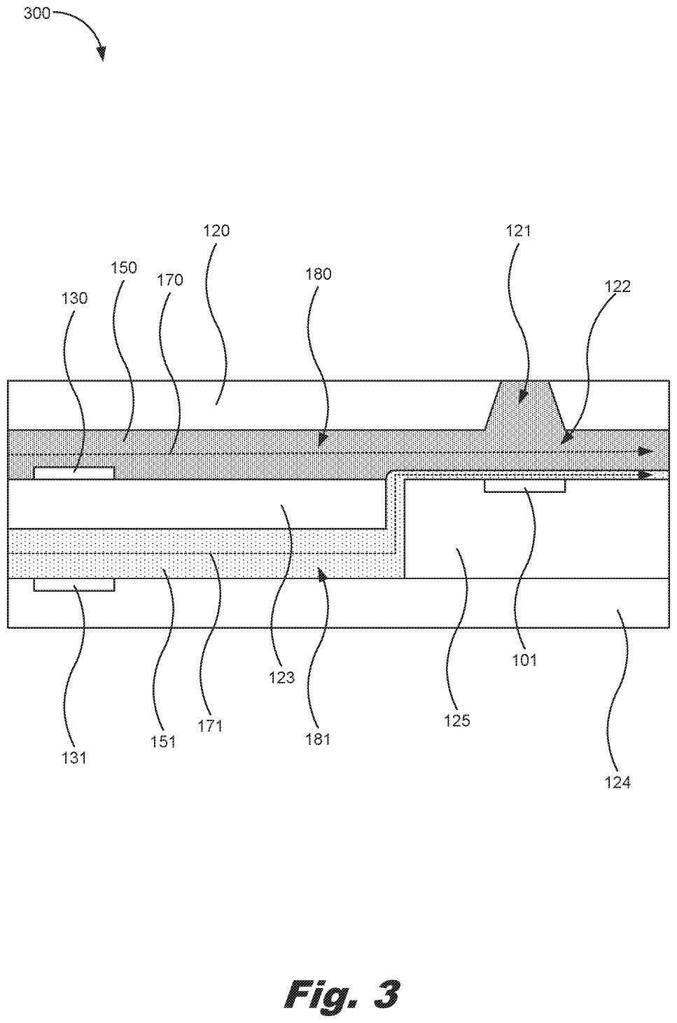

FIG. 3 is a side, cutaway view of a, block diagram of a fluidic device (300) at an initial state before fluid ejection, according to an example of the principles described herein. The example of FIG. 3 includes those elements described above in connection with FIGS. 1 and 2 and elsewhere herein, and may also include an actuator support layer (125) located between the substrate layer (124) and the actuator (101) and first fluid channel (180). At the initial state of the fluidic device (300), the drive bubble has not been formed, but the fluids (150, 151) are moving within the fluid channels (180, 181) and the fluid ejection chamber (122).

FIG. 4 is a side, cutaway view of a, block diagram of the fluidic device (300) of FIG. 3 at an ejection state, according to an example of the principles described herein. As depicted in FIG. 4, the actuator (101) may be activated, and a drive bubble (401) may be formed from the second fluid (151). The drive bubble (401) increases the pressure within the fluid ejection chamber (122) and within the nozzle (121). This increase in pressure causes a volume of the first fluid (150) to be ejected out of the fluid ejection chamber (122) and nozzle (121) to form a droplet (403) of the first fluid (150). In this manner, a volume of the first fluid (150) may be dispensed onto, for example, print media. A convex meniscus (402) maybe formed by the drive bubble (401), and that volume of the first fluid (150) within the convex meniscus (402) may be drawn back into the nozzle (121) and the fluid ejection chamber (122) as the drive bubble (401) collapses.

In one example, the fluids (150, 151) may have any chemical composition or other physical properties that are suitable for the fluids (150, 151) to fulfill their roles as an ejection fluid and a drive fluid, respectively. For example, the first fluid (150) and the second fluid (151) are non-aqueous and aqueous respectively, aqueous and non-aqueous respectively, both aqueous, both non-aqueous, a non-polar solvent and a polar solvent respectively, a polar solvent and non-polar solvent respectively, miscible, immiscible, a suspension, an emulsion, or combinations thereof.

In the examples described herein, the fluids may be caused to mix at some level or degree as they come into contact with one another in their laminar flows within the first fluid channel (180) and the fluid ejection chamber (122) or other portions of the fluidic devices or systems. The amount of interaction and mixing of the fluids (150, 151) is a function of the diffusion properties of the two fluids (150, 151) and the flow velocities. In some examples, the fluids (150, 151) may be mixed at controlled ratios depending upon how far down the fluid passageways within the fluidic devices or systems the fluids flow together. In these examples of mixing of the fluids (150, 151), the mixing of the fluids (150, 151) may serve to complete one or both of the fluids (150, 151) as co-reactants or as intentionally miscible fluids that impart a chemical property or characteristic to the first fluid (150), the second fluid (151) or both.

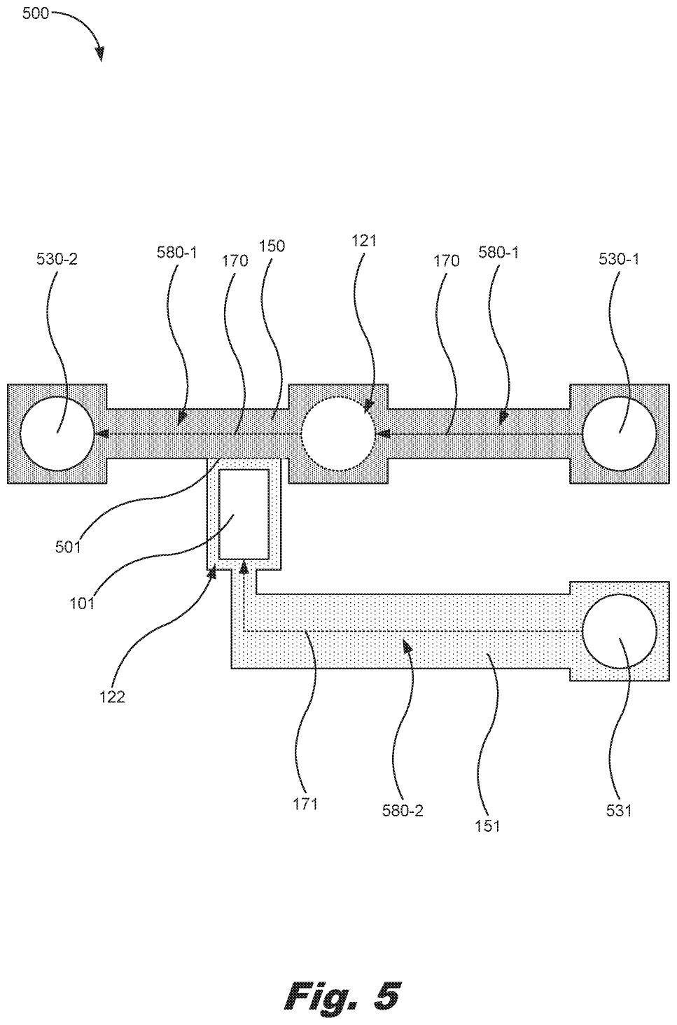

FIGS. 5 through 9 depict different fluidic devices with differing architectures. FIG. 5 is a top, cutaway view of a block diagram of a fluidic device (500), according to an example of the principles described herein. The architecture of the fluidic device (500) may include a first fluid channel (580-1) that includes a first pump (530-1) and a second pump (530-2) that causes the first fluid (150) to flow in the direction of arrow (170). The first fluid channel (580-1) includes the nozzle (121) through which the first fluid (150) is ejected in the direction of the viewer of FIG. 5.

The fluid device (500) may include a second fluid channel (580-2) fluidically coupled to the first fluid channel (580-1). In the example of FIG. 5, the second fluid channel (580-2) may run parallel with the first fluid channel (580-1), turn towards the first fluid channel (580-1), and fluidically couple to the first fluid channel (580-1). The second fluid channel (580-2) may also include a pump (531) to move the second fluid (151) in the direction of arrow (171). With flow of the first fluid (150) in the first fluid channel (580-1) flowing therethrough, the second fluid channel (580-2) and/or the third fluid channel (580-3) are filled with refreshing amounts of the second fluid (151). The fluidic devices (500, 600, 700, 800, 900) may force the drive bubble (FIG. 4, 401) from the second fluid channel (580-2) and/or the third fluid channel (FIGS. 6 and 7, 580-3) and direct it towards the nozzle (121) in order to eject a volume of the first fluid (150). In the examples described herein, the interaction between the drive bubble (FIG. 4, 401) and the actuator (101) may be reduced and the architecture and use of two separate fluids (150, 151) improves the lifespan of the actuators (101).

In the example of FIG. 5, the actuator (101) may be located off-center with respect to the nozzle (121) and within the second fluid channel (580-2). In this example, as the actuator (101) is activated, the drive bubble (FIG. 4, 401) forms on top of the actuator (101) within the fluid ejection chamber (122), and the pressure added to the first fluid channel (580-1) and the second fluid channel (580-2) of the fluidic device (500) from the drive bubble (FIG. 4, 401) causes the first fluid (150) to be ejected from the nozzle (121).

The dashed line (501) may define a general boundary at which the first fluid (150) and the second fluid (151) meet. In one example, the pump (531) within the second fluid channel (580-2) may cause the second fluid (151) to flow at a slower rate relative to the rate at which the pumps (530-1, 530-2) within the first fluid channel (580-1) cause the first fluid (150) to flow. In an example, the second fluid (151) may be pumped by the pump (531) at a rate at which the second fluid (151) is consumed as the first fluid (150) is ejected from the nozzles (121) to limit or preclude mixing of the two fluids (150, 151) at the interface of the fluids (150, 151) at the dashed line (501).

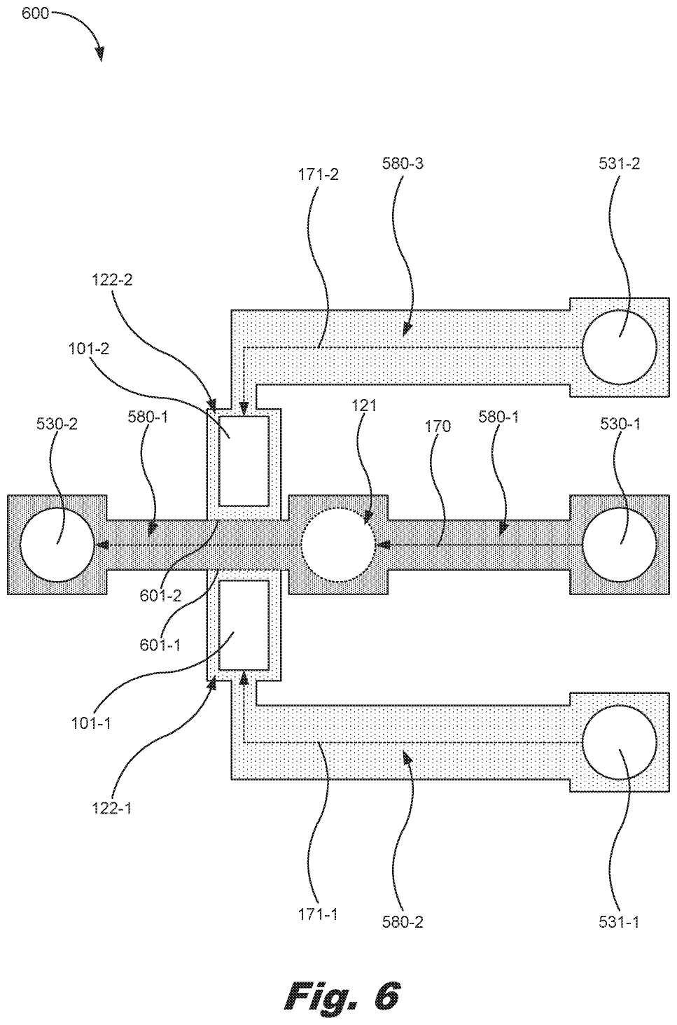

FIG. 6 is a top, cutaway view of a block diagram of a fluidic device (600), according to an example of the principles described herein. The architecture of the fluidic device (600) may include a first fluid channel (580-1) that includes a first pump (530-1) and a second pump (530-2) that causes the first fluid (150) to flow in the direction of arrow (170) as described above in connection with FIG. 5. The first fluid channel (580-1) includes the nozzle (121) through which the first fluid (150) is ejected in the direction of the viewer of FIG. 6. The fluid device (600) may include a second fluid channel (580-2) and a third fluid channel (580-3) both fluidically coupled to the first fluid channel (580-1). In the example of FIG. 5, the second fluid channel (580-2) and the third fluid channel (580-3) both may run parallel with the first fluid channel (580-1), turn towards the first fluid channel (580-1), and fluidically couple to the first fluid channel (580-1). Each of the second fluid channel (580-2) and the third fluid channel (580-3) may also include a pump (531-1, 531-2) to move the second fluid (151) in the direction of arrows (171-1, 171-2), respectively.

In the example of FIG. 6, the actuators (101-1, 101-2) may be located off-center with respect to the nozzle (121) and within the second fluid channel (580-2) and third fluid channel (580-3), respectively. In this example, as the actuators (101-1, 101-2) are activated, the drive bubble (FIG. 4, 401) forms on top of the actuators (101-1, 101-2) within the fluid ejection chambers (122-1, 122-2), and the pressure added to the first fluid channel (580-1), the second fluid channel (580-2), and the third fluid channel (580-3) of the fluidic device (600) from the drive bubble (FIG. 4, 401) causes the first fluid (150) to be ejected from the nozzle (121).

The dashed lines (601-1, 601-2) may define a general boundary at which the first fluid (150) and the second fluid (151) meet. In one example, the pumps (531-1, 531-2) within the second fluid channel (580-2) and third fluid channel (580-3), respectively, may cause the second fluid (151) to flow at a slower rate relative to the rate at which the pumps (530-1, 530-2) within the first fluid channel (580-1) cause the first fluid (150) to flow. In an example, the second fluid (151) may be pumped by the pumps (531-1, 531-2) at a rate at which the second fluid (151) is consumed as the first fluid (150) is ejected from the nozzles (121) to limit or preclude mixing of the two fluids (150, 151) at the interface of the fluids (150, 151) at the dashed lines (601-1, 601-2).

The fluidic device (600) of FIG. 6 differs from the fluidic device (500) of FIG. 5 by the inclusion of a mirrored fluidic channels (580-2, 580-3) and actuators (101-1, 101-2). This mirrored arrangement provides for an example of simultaneous drive bubble (FIG. 4, 401) formation through simultaneous activation of the actuators (101-1, 101-2) that balances the effect of the collapse of the drive bubble (FIG. 4, 401). The effect of drive bubble (FIG. 4, 401) collapse is that the collapse causes the first fluid (150) to be drawn back into the fluidic device (600) and away from the nozzle (121) and causes the second fluid (151) to rush into the area above the actuators (101-1, 101-2), In an example, the actuators (101-1, 101-2) may be activated non-simultaneously, opposite or asynchronously to the activation of the other. In this example, the activation of either actuator (101-1, 101-2) may provide enough pressure to build within the fluid channels (580-1, 580-2, 580-3) enough to force the first fluid (150) out of the nozzle (121). In this manner, the first fluid (150) may be ejected from the fluidic device (600) at a higher frequency then if the actuators (101-1, 101-2) are activated simultaneously. Further, the mirrored arrangement of the fluidic channels (580-2, 580-3) and actuators (101-1, 101-2) provides for a balancing of forces on the ejected droplet, reducing printing defects that may result from, for example, trajectory errors that are sometimes associated with asymmetry.

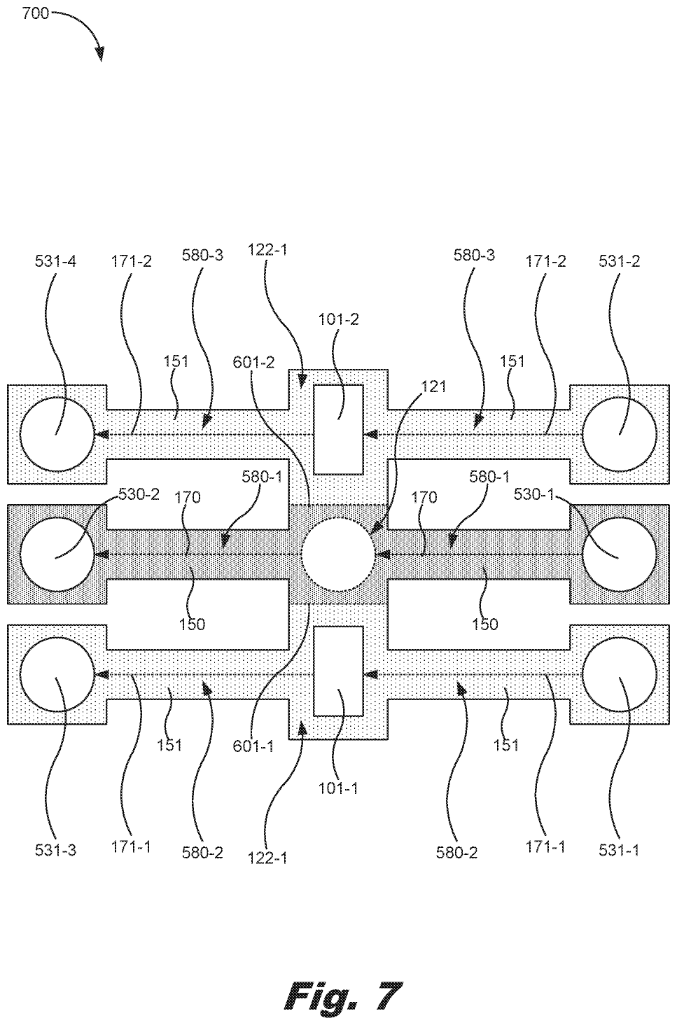

FIG. 7 is a top, cutaway view of a block diagram of a fluidic device (700), according to an example of the principles described herein. The fluidic device (700) of FIG. 7 differs from the fluidic devices (500, 600) of FIGS. 5 and 6 by the inclusion of a mirrored fluidic channels (580-2, 580-3) and actuators (101-1, 101-2) where the actuators (101-1, 101-2) are axially aligned with the nozzle (121) in a first axis. This mirrored arrangement provides for the simultaneous, asynchronous, and random activation of the actuators (101-1, 101-2) as described herein.

In the example of FIG. 7, the fluid channels (580-1, 580-2, 580-3) run parallel to one another. The two fluid channels (580-2, 580-3) running parallel with the first fluid channel (580-1) each include two pumps (531-1, 531-2, 531-3, 531-4) that move the fluid in the direction of arrows 171-1 and 171-2 across their respective actuators (101-1, 101-2). The first fluid (150) within the first fluid channel (580-1) moves from pump (530-1) to pump (530-2) as indicated by arrow (170) and as described herein. Further, the flow of the second fluid (151) within the second fluid channel (580-2) and the third fluid channel (580-3) moves from pumps (531-1, 531-2) to pumps (531-3, 531-4) as indicated by arrows (171-1, 171-2), respectively, and across their respective actuators (101-1, 101-2). The dashed lines (601-1, 601-2) may define a general boundary at which the first fluid (150) and the second fluid (151) meet, and the flow of the first fluid (150) and the second fluid (151) may be controlled through the activation of the pumps (530-1, 530-2, 531-1, 531-2, 531-3, 531-4) such that the fluid may be allowed to mix or not depending on the desired level of mixing of the fluids (150, 151).

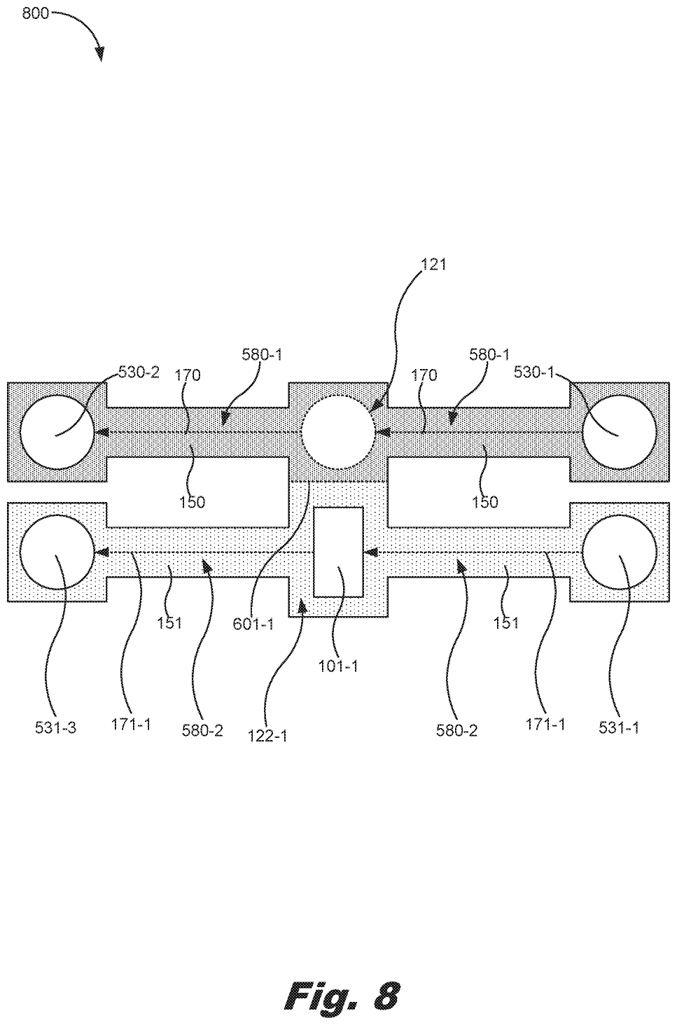

FIG. 8 is a top, cutaway view of a block diagram of a fluidic device, according to an example of the principles described herein. The architecture of the fluidic device (800) may include a first fluid channel (580-1) that includes a first pump (530-1) and a second pump (530-2) that causes the first fluid (150) to flow in the direction of arrow (170) as described above in connection with FIG. 5. The first fluid channel (580-1) includes the nozzle (121) through which the first fluid (150) is ejected in the direction of the viewer of FIG. 8. The fluid device (800) may include a second fluid channel (580-2) fluidically coupled to the first fluid channel (580-1). In the example of FIG. 8, the second fluid channel (580-2) may run parallel with the first fluid channel (580-1) and fluidically couple to the first fluid channel (580-1) at the fluid ejection chamber (122) of the second fluid channel (580-2). The second fluid channel (580-2) may also include a pump (531-1) to move the second fluid (151) in the direction of arrows (171-1). The example of FIG. 8 differs from, for example, FIG. 7, by not including the third fluid channel (FIG. 7, 580-3). Further, example of FIG. 8 differs from, for example, FIGS. 5 and 6, by not including a second fluid channel (580-2) or a third fluid channel (FIG. 7, 580-3) that runs parallel with the first fluid channel (580-1) and then turns toward and fluidically couples to the firs fluid channel (580-1), but instead continue to run to parallel with the first fluid channel (580-1).

In the example of FIG. 8, the actuator (101-1) may be located off-center with respect to the nozzle (121) within the second fluid channel (580-2), but axially aligned with the nozzle (121) in a first axis. In this example, as the actuator (101-1) is activated, the drive bubble (FIG. 4, 401) forms on top of the actuator (101-1) within the fluid ejection chamber (122-1), and the pressure added to the first fluid channel (580-1) and the second fluid channel (580-2) of the fluidic device (800) from the drive bubble (FIG. 4, 401) causes the first fluid (150) to be ejected from the nozzle (121).

The dashed line (601-1) may define a general boundary at which the first fluid (150) and the second fluid (151) meet. In one example, the pumps (531-1, 531-3) within the second fluid channel (580-2) may cause the second fluid (151) to flow at a faster or slower rate relative to the rate at which the pumps (530-1, 530-2) within the first fluid channel (580-1) cause the first fluid (150) to flow. In an example, the second fluid (151) may be pumped by the pumps (531-1, 531-3) at a rate at which the second fluid (151) is consumed as the first fluid (150) is ejected from the nozzles (121) to limit or preclude mixing of the two fluids (150, 151) at the interface of the fluids (150, 151) at the dashed line (601-1).

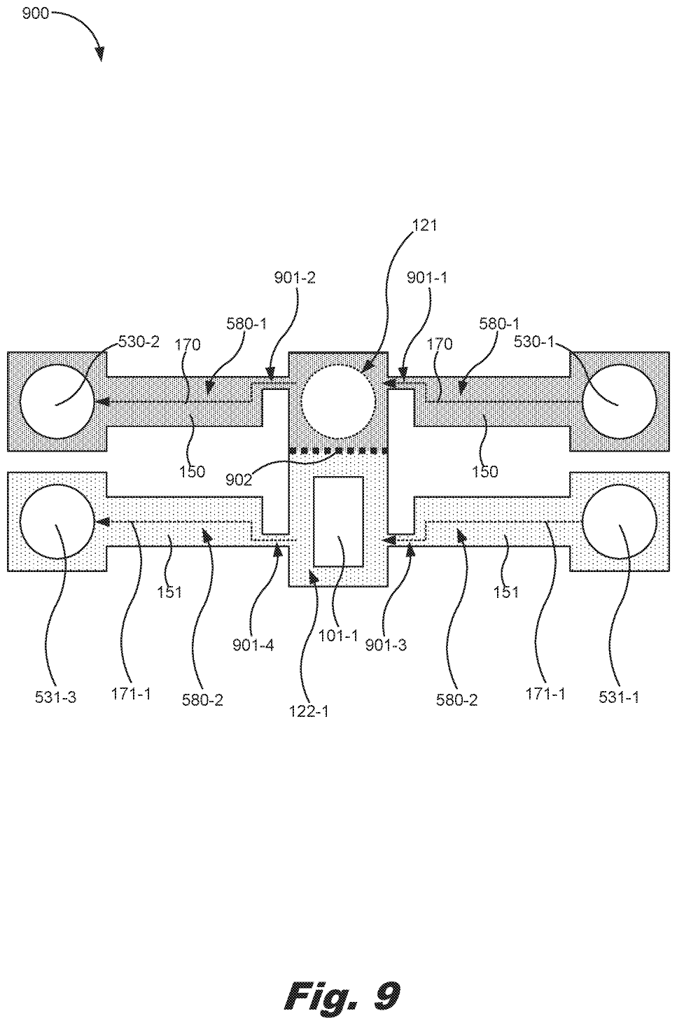

FIG. 9 is a top, cutaway view of a block diagram of a fluidic device, according to an example of the principles described herein. The architecture of the example of the fluidic device (900) of FIG. 9 includes those elements described herein in connection with FIG. 8. The example of FIG. 9 includes a number of narrow portions (901-1, 901-2, 901-3, 901-4, collectively referred to herein as 901) defined within the first fluid channel (580-1) and the second fluid channel (580-2), respectively. The narrow portions may include at least a portion of the first fluid channel (580-1) and/or the second fluid channel (580-2) that includes a cross-sectional area that is smaller or narrower than a remaining portion of the fluid channel (580-1, 580-2). The narrow portions (901) serve to reduce blowback outside of the fluid ejection chamber (122-1) and force the drive bubble (FIG. 4, 401) toward the first fluid channel (580-1) and the nozzle (121) in order to force the first fluid (150) out the nozzle (121).

Although both the first fluid channel (580-1) and the second fluid channel (580-2) include narrow portions (901), in one example, the first fluid channel (580-1) or the second fluid channel (580-2) may include narrow portions (901) such that a fluid (150, 151) within one or the other of the first fluid channel (580-1) or the second fluid channel (580-2) flows at a relatively decreased rate with respect to the other. Thus, in this example, at least a portion of one of the first fluid channel (580-1) or the second fluid channel (580-2) may include a cross-sectional area that is smaller or narrower than a remaining portion of that fluid channel (580-1, 580-2) and any portion of the other fluid channel (580-1, 580-2).

The example of FIG. 9 also includes a permeable flow separator (902) that serves to reduce mixing between the fluids (150, 151) in the first fluid channel (580-1) and the second fluid channel (580-2). The permeable flow separator (902) may include a cross-sectional area that is narrower than the first fluidic channel and the second fluidic channel. The permeable flow separator (902) may include elements that are dimensioned to allow vapor transmission during a fluid ejection event. Further, the permeable flow separator (902) may be positioned in a vertical or horizontal orientation to create a vertical or horizontal barrier as is demonstrated herein. Thus, the combination of the narrow portions (901) and the permeable flow separator (902) assist in separating the two fluids (150, 151) and directing energy of the drive bubble (FIG. 4, 401) to improve thermal efficiency within the fluidic device (900). Because drive bubbles (FIG. 4, 401) are vapor, the viscous losses through the narrow portions (901) is very small, while liquids will have greater viscous losses.

In the examples of FIGS. 5-9, recovering of any depletion of the first fluid (150) may be eliminated by using the second fluid (151). These examples provide for parallel, recirculation of the second fluid (drive fluid) (151), and a balanced drive bubble (FIG. 4, 401) formation and collapse. In one example, the second fluid (151) may be replaced after a certain amount of time due to contamination from the first fluid (151). In an example, the second, drive fluid (151) may be formulated to optimize drive bubble formation and flow through the micro channels (580), and, in an example, the flow rate of the second fluid (151) may be significantly less than the flow rate of the first fluid (150). Further, in an example, the fluid channels (580) for the second fluid (151) may be narrower and more constricting due to lower flow rates or reduced viscosity.

Further, in the examples of FIGS. 5-9, use of the fluid channels (580) and pumps (530, 531) as a recirculation system, fresh amounts of the first fluid (150) is supplied to the fluid ejection chamber in cases where the actuator (101) and the nozzle (121) are coaxially aligned (see, e.g., FIGS. 1 through 4) and to an evacuation area surrounding the nozzle (121) in examples where the actuator (101) and the nozzle (121) are not coaxially aligned (see, e.g., FIGS. 5-9). This recirculation of fresh amounts of the first fluid (150) compensates for the volatile components such as water that may be lost through the nozzle (121). Over time, this may result in depletion of bulk amounts of the first fluid (150). Thus, the role of the second fluid (151) is to replace the first fluid (150) as the drive fluid, eliminates the loss of the first fluid (150) or any of its components such as pigments, binders, and other components. In one example, the second fluid (151) may be void of those components such as the pigment, binders, and other components to eliminate fluid loss and to ensure that the actuator (101) is not contaminated or damaged through the vaporization of these components.

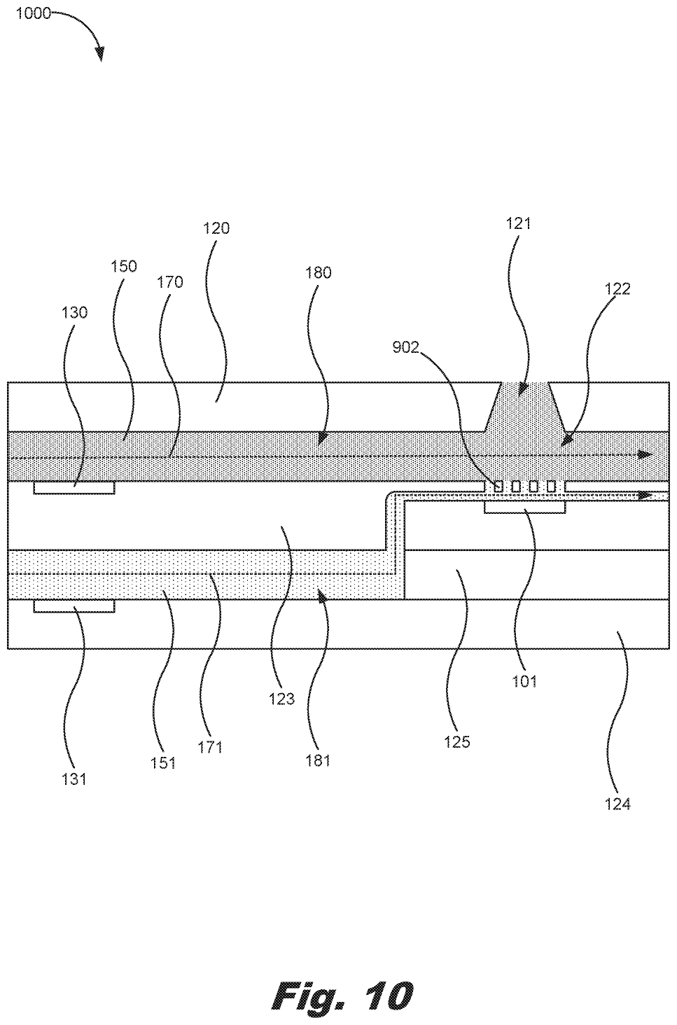

FIG. 10 is a side, cutaway view of a, block diagram of a fluidic device, according to an example of the principles described herein. The architecture of the example of the fluidic device (1000) of FIG. 10 includes those elements described herein in connection with FIGS. 1 through 9. The example of FIG. 10 depicts the manner in which the permeable flow separator (902) is oriented in a vertical orientation between the actuator (101) and the nozzle (121). The example fluidic device (1000) of FIG. 10 functions in a similar manner as the example of FIG. 9, except that the permeable flow separator (902) functions in the vertical direction to reduce mixing between the fluids (150, 151) in the first fluid channel (180) and the second fluid channel (181) allow vapor transmission during a fluid ejection event.

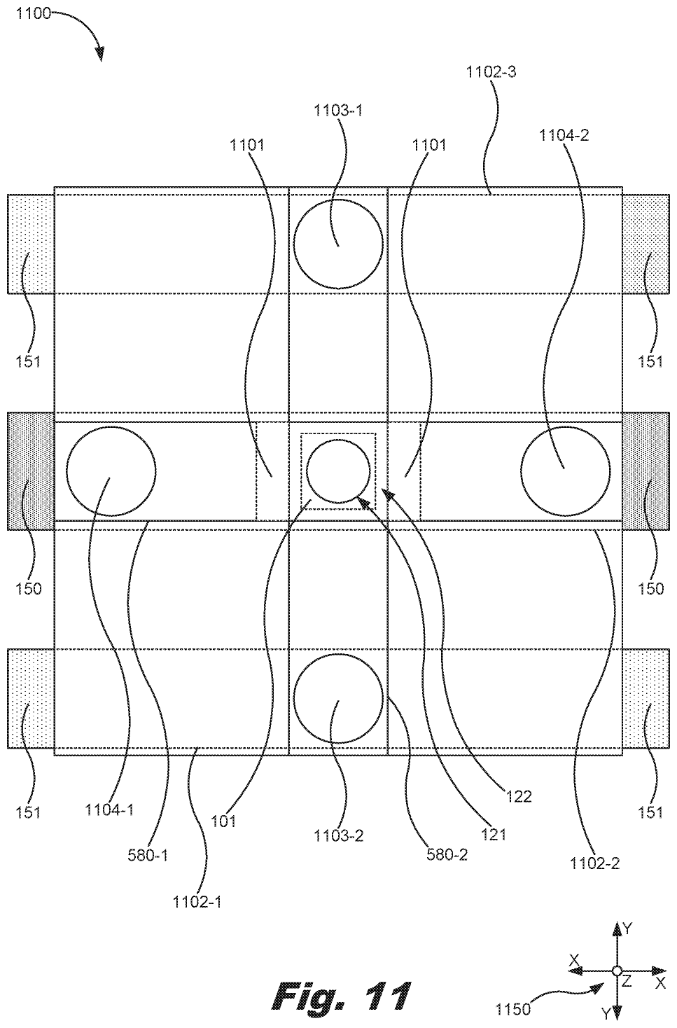

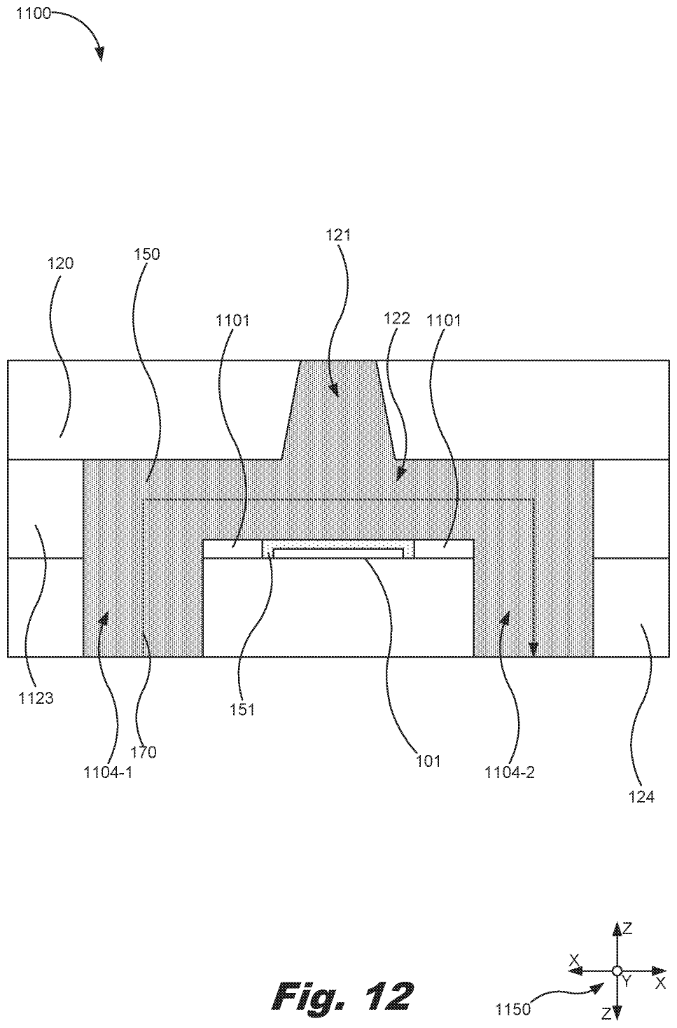

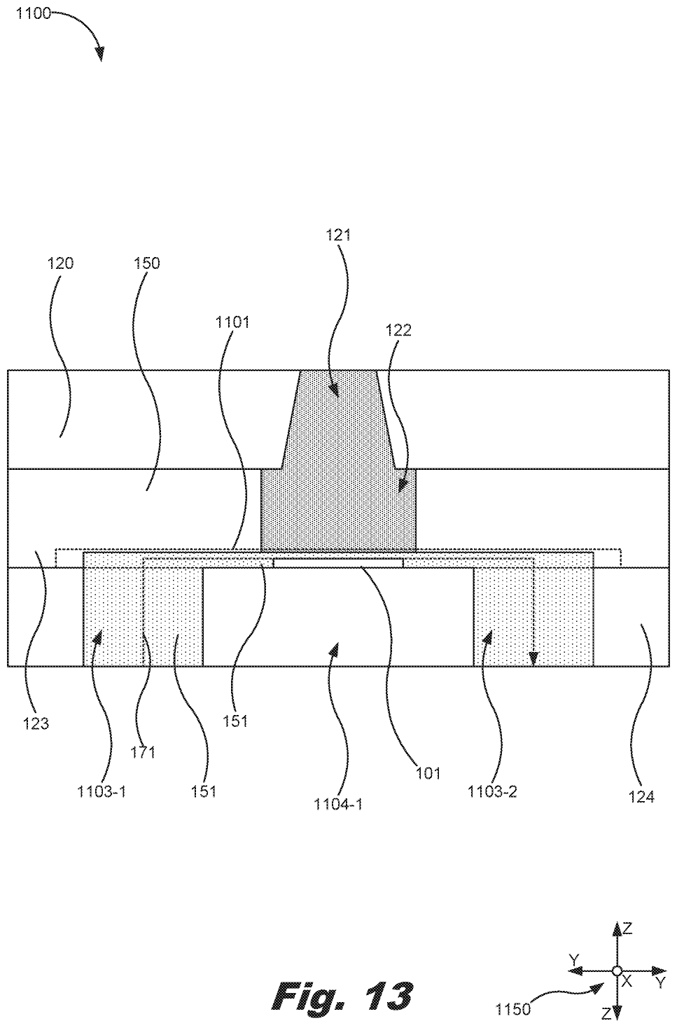

FIGS. 11 through 13 describe a fluidic device (1100) that includes a laminar flow of fluids (150, 151) using a cross flow of the two fluids (150, 151). FIG. 11 is a top, cutaway view of a block diagram of a fluidic device (1100), according to an example of the principles described herein. FIG. 12 is a first side, cutaway view of a block diagram of the fluidic device (1100) of FIG. 11, according to an example of the principles described herein. FIG. 13 is a second side, cutaway view of a block diagram of the fluidic device (1100) of FIG. 11, according to an example of the principles described herein. The coordinate indicator (1150) is used to indicate the orientation of FIGS. 11 through 13 with respect to one another.

As depicted in FIG. 11, a number of fluid slots (1102-1, 1102-2, 1102-3, collectively referred to herein as 1102). Fluid slot (1102-2) carries the first fluid (150) that is ejected from the fluidic device (1100). Fluid slots (1102-1, 1102-3) carry the second fluid (151) that is used to form the drive bubble (FIG. 4, 401) via activation of the actuator (101) to, in turn, eject the first fluid (150) from the nozzle (121).

Fluid slot (1102-2) includes fluid feed holes (1104-1, 1104-2) that deliver the first fluid (150) to the fluid channel (580-1). Once the first fluid (150) enters the fluid channel (580-1), the first fluid (150) may be delivered to the fluid ejection chamber (122), and interact with the drive bubble (FIG. 4, 401) formed from the second fluid (151). Likewise, the fluid slots (1102-1, 1102-3) include fluid feed holes (1103-1, 1103-2) that deliver the second fluid (151) to the fluid channel (580-2). Once the second fluid (151) enters the fluid channel (580-2), the second fluid may be delivered to the fluid ejection chamber (122) in a laminar flow between the first fluid (150) and the actuator (101).

The fluidic device (1100) may also include a chamber layer (1123). As part of the chamber layer (1123), a couple of rails (1101) may be included. The rails (1101) serve to provide an area in the second fluid channel (580-2) along which the second fluid (151) may flow, and creates an area above the actuator (101) at which the second fluid (151) may be pooled to allow for an amount of the second fluid (151) to be vaporized in order to form the drive bubble (FIG. 4, 401). The first fluid (150) flows in the direction of arrow (170) and the second fluid (151) flows in the direction of arrow (171). This crossing laminar flow of the fluids (150, 151) allows for space in the fluidic device (1100) to be managed and provides for flexibility in the architecture of the fluidic device (1100).

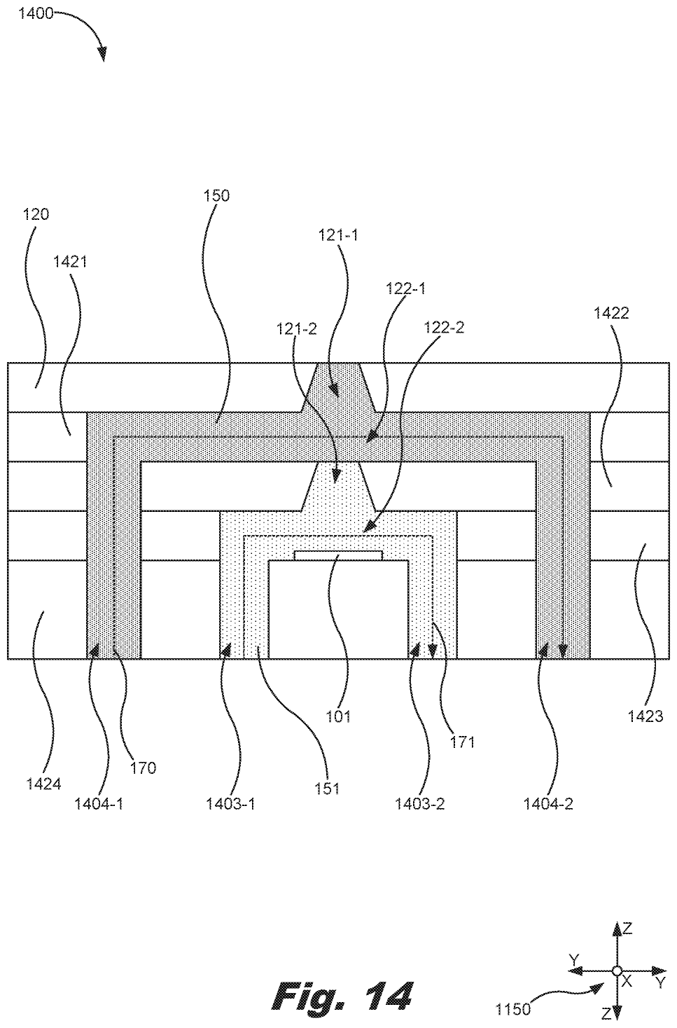

FIG. 14 is a side, cutaway view of a block diagram of a fluidic device (1400) including two nozzles (121-1, 121-2), according to an example of the principles described herein. As described herein, the second fluid (151) is used to form a drive bubble (FIG. 4, 401) to force the first fluid (150) out of the nozzle (121-1) of the fluidic device (1400). In the example of FIG. 14, the fluidic device (1400) includes two separate nozzles (121-1, 121-2) stacked on top of one another in the z-direction as indicated by the coordinate indicator (1150).

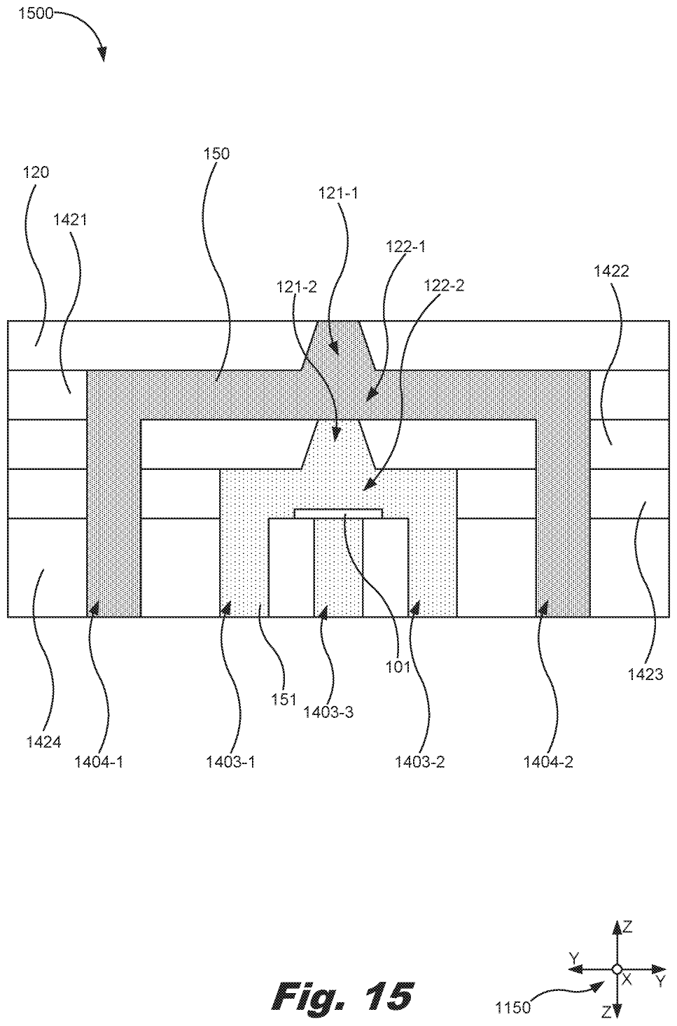

The fluidic device (1400) of FIG. 14 includes a nozzle layer (120), and a first chamber layer (1421) that forms the first fluid ejection chamber (122-1) associated with the first fluid (150). The fluidic device (1400) also includes a second nozzle layer (1422) and a second chamber layer (1423) that forms the second ejection chamber (122-2) associated with the second fluid (151). A substrate layer (1424) supports the actuator (101). The manner in which the actuator (101) forms the drive bubble to eject the first fluid (150) is described herein in connection with the similar example of FIGS. 15 through 20.

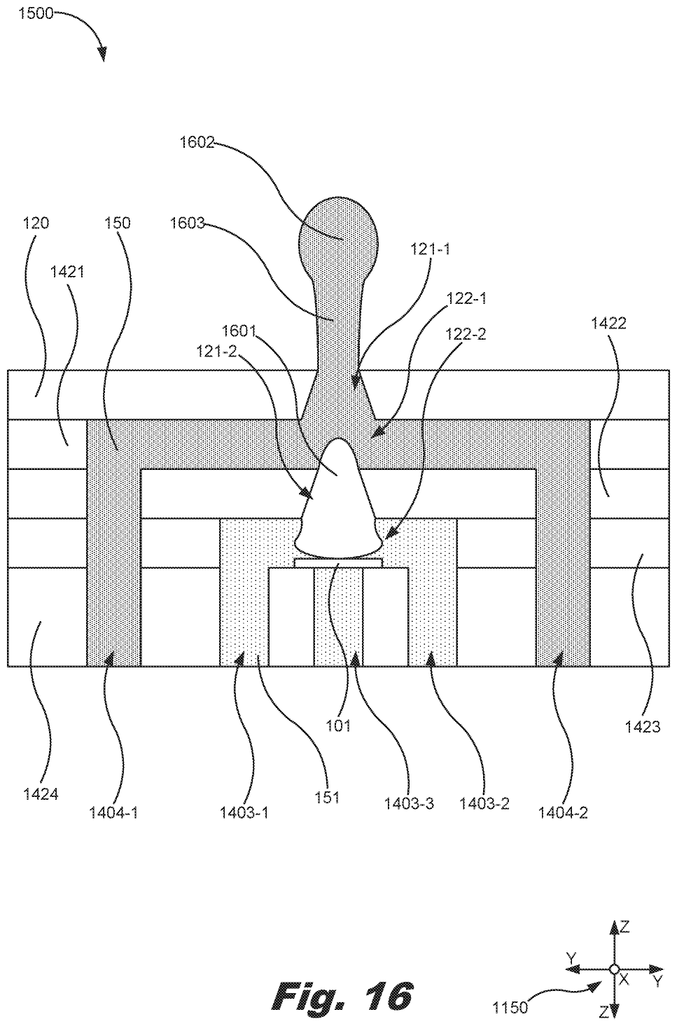

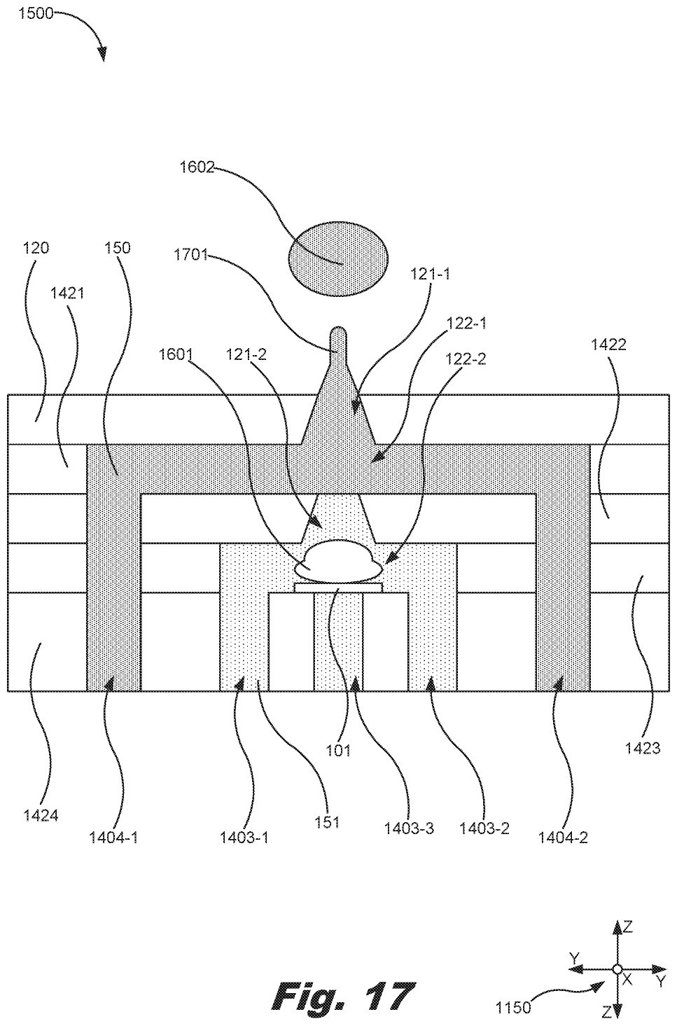

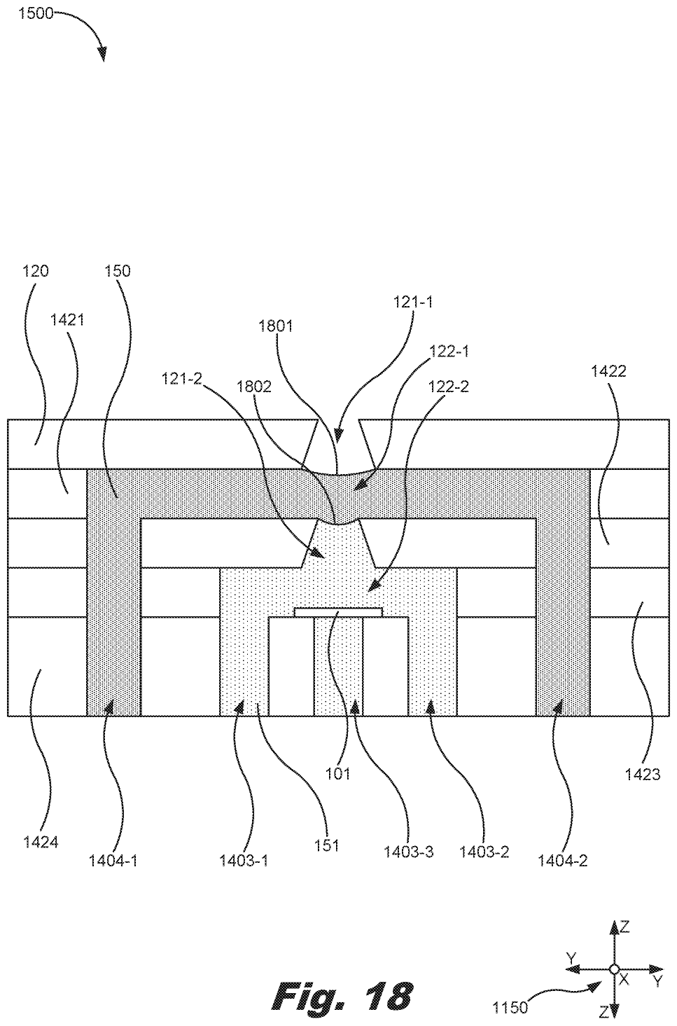

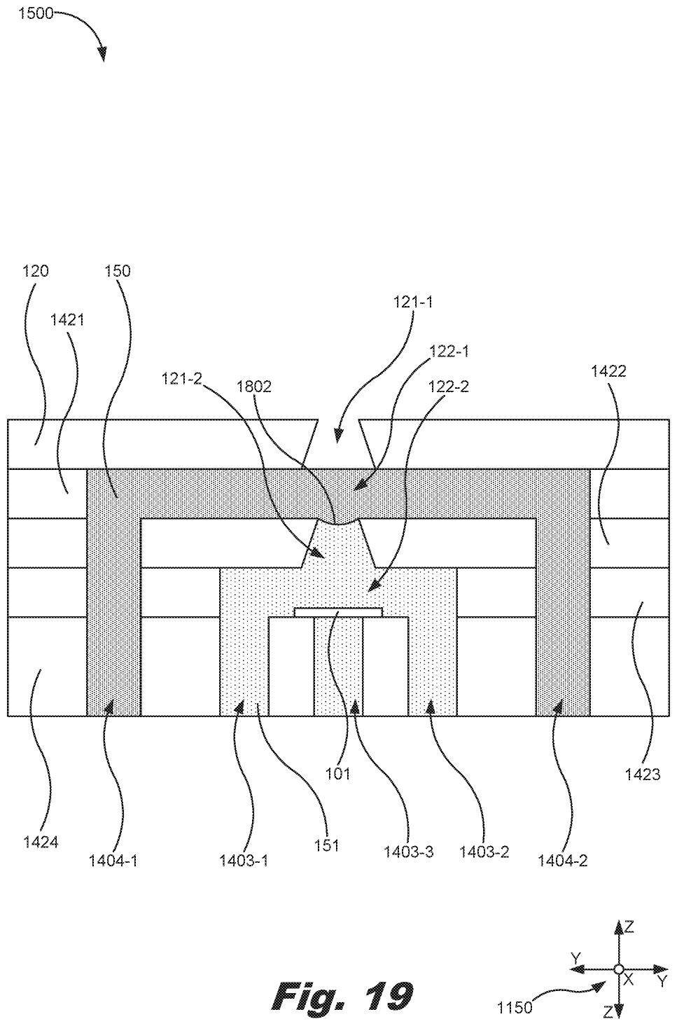

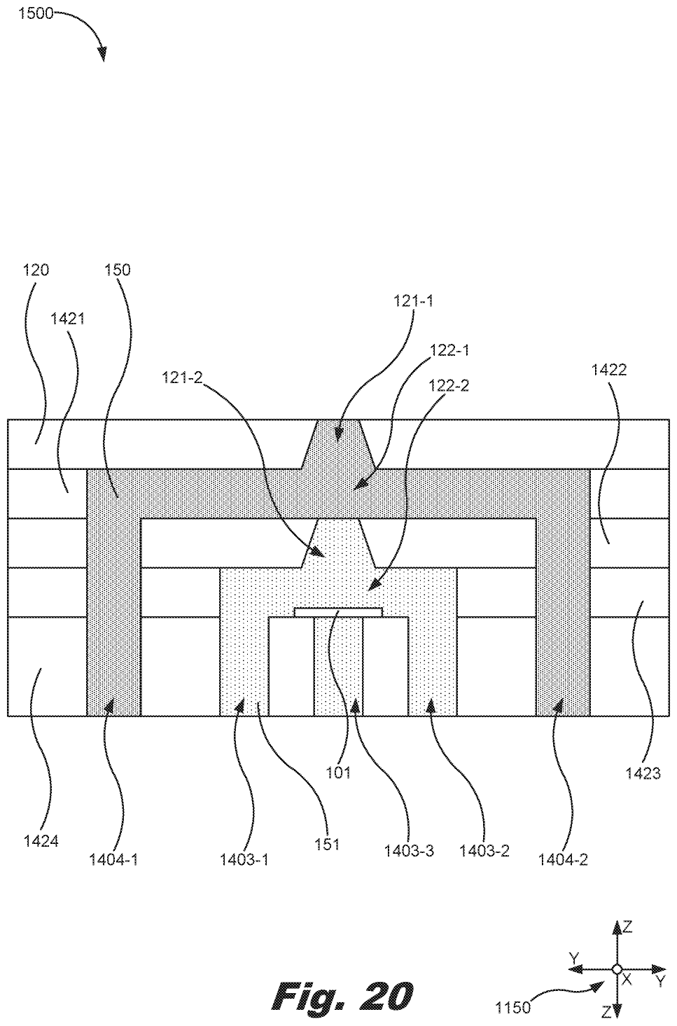

FIGS. 15 through 20 depict an example of a fluidic device (1500) and the manner in which the fluidic devices (1400, 1500) of both FIGS. 14 and 15 through 20 function through utilization of the two fluids (150, 151). FIG. 15 is a side, cutaway view of a block diagram of a fluidic device (1500) including two nozzles (121-1, 12102), according to an example of the principles described herein. FIG. 16 is a side, cutaway view of a block diagram of the fluidic device (1500) of FIG. 15 at an initial state of ejection, according to an example of the principles described herein. FIG. 17 is a side, cutaway view of a block diagram of the fluidic device (1500) of FIG. 15 at a subsequent state of ejection, according to an example of the principles described herein. FIG. 18 is a side, cutaway view of a block diagram of the fluidic device (1500) of FIG. 15 at a subsequent state of ejection, according to an example of the principles described herein. FIG. 19 is a side, cutaway view of a block diagram of the fluidic device (1500) of FIG. 15 at a subsequent state of ejection, according to an example of the principles described herein. FIG. 20 is a side, cutaway view of a block diagram of the fluidic device (1500) of FIG. 15 at a subsequent state of ejection, according to an example of the principles described herein. The example of FIG. 15 includes those elements described above in connection with FIG. 14 and elsewhere herein, and may also include an additional fluid channel (1403-3) to assist in the delivery of the second fluid (151) to the second fluid ejection chamber (122-2).

The manner in which the examples of FIGS. 14 and 15 through 20 will now be described in more detail. FIG. 15 depicts the fluidic device (1400, 1500) in an initial state before the activation of the actuator (101). In this state, the fluids (150, 151) fill their respective fluid channels (1404-1, 1403-1, 1403-2, 1403-3) and nozzles (121-1, 121-2). As depicted in FIG. 16, a voltage is applied to the actuator (101) to activate the actuator (101) and create a drive bubble (1601) in the second fluid ejection chamber (122-2) from the second fluid (151) within the second fluid channel (1403-1, 1403-2, 1403-3). The drive bubble (1601) is forced though the second nozzle (121-2) and displaces the first fluid (150) within the first fluid channel (1404-1, 1404-2) and the first fluid ejection chamber (122-1). The displacement of the first fluid (150) causes an amount of the first fluid (150) to be ejected from the fluidic device (1400, 1500) through the first nozzle (121-1).

At the stage of ejection depicted in FIG. 16, the droplet (1602) is formed, but still remains as an attached portion of the first fluid (150) within the fluidic device (1400, 1500) through a column (1603) of the fluid (150). In FIG. 17, the droplet (1602) has separated from the column (1603), and a suspending volume (1701) of the fluid (150) remains outside the nozzle (121-1). The drive bubble (121-2) begins to collapse, and the second fluid (151) begins to fill those portions of the second nozzle (121-2) and second fluid ejection chamber (122-2) to replace the area within those elements that were previously filled with the drive bubble (1601).

FIGS. 18 through 20 include the post-ejection refilling of fluid passageways within the fluidic device (1400, 1500). In FIG. 18, the first fluid (150) is drawn back into the first fluid channel (1404-1) and the first fluid ejection chamber (122-1) and forms a first concave meniscus (1801) as the first fluid (150) recedes. Similarly, a second concave meniscus (1802) may be formed as the second fluid (151) also returns to its initial levels and positions as depicted in FIG. 15. In FIG. 19, the first meniscus (FIG. 18, 1801) subsides, but the second meniscus (1802) remains. In FIG. 20, the second meniscus (FIG. 18, 1802) subsides, the first nozzle (121-1) fills to the end of the nozzle (121-1), and the fluidic device (1400, 1500) returns to its initial state as depicted in FIGS. 14 and 15.

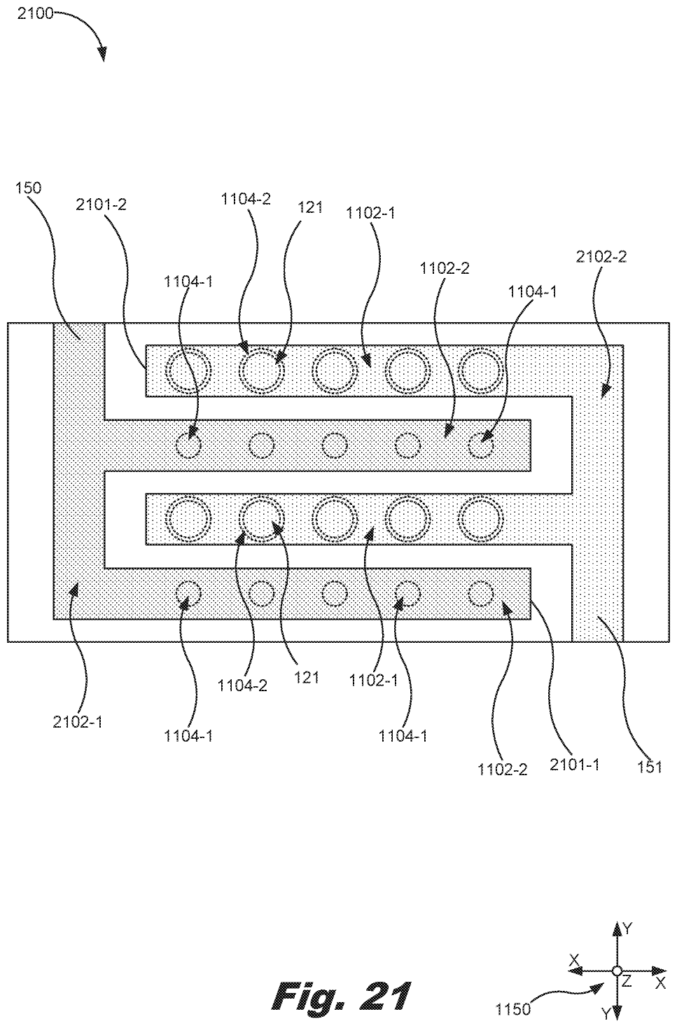

FIG. 21 is a top, cutaway view of a block diagram of fluidic feed channels of the fluidic devices (1100, 1400, 1500) of FIGS. 11 through 20, according to an example of the principles described herein. The first fluid (150) may flow within the first fluid slots (1102-1), and the second fluid (151) may flow within the second fluid slots (1102-2). The fluid slots (1102-1, 1102-2) may include branched architectures (2101-1, 2101-2) that extend from a main channel (2102-1, 2102-2). In this example, the branches (2101-1) of the first fluid slot (1102-1) extend from the first main channel (2102-1) and run parallel with the branches (2101-2) of the second fluid slot (1102-2) that extend from the second main channel (2102-2). In this manner, the fluids (150, 151) may be delivered to the respective fluid feed holes (1104-1, 1104-2) to be used as described herein in connection with the examples of the fluidic devices.

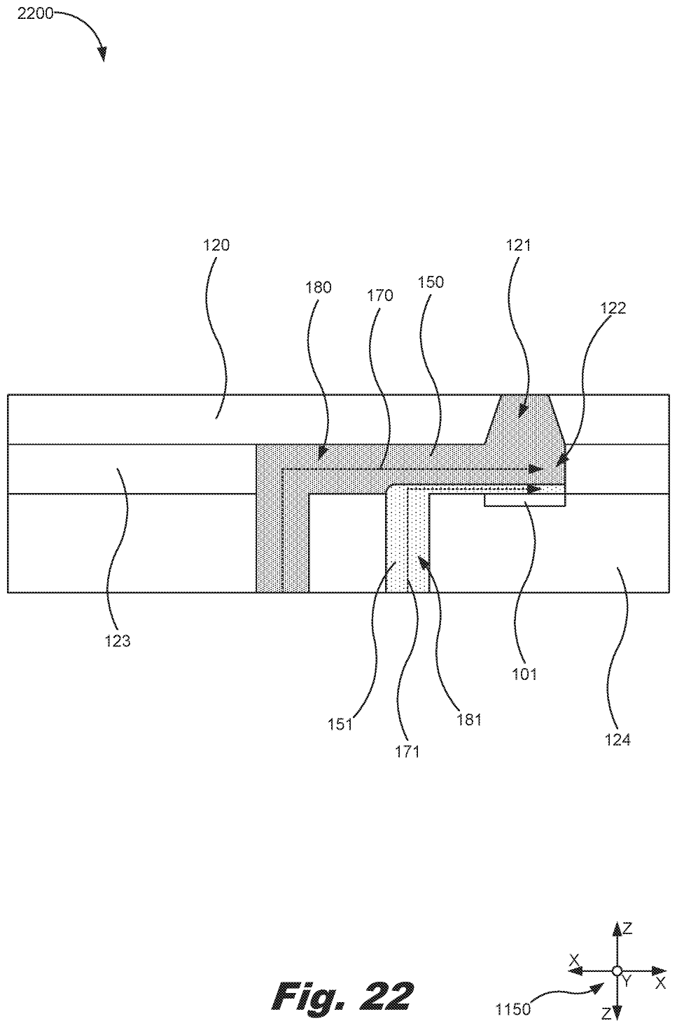

FIG. 22 is a side, cutaway view of a block diagram of a fluidic device (2200), according to an example of the principles described herein. The example of FIG. 22 includes those elements described in connection with the examples of FIGS. 1 through 21 and elsewhere herein, and may also include a first fluid channel (180) and a second fluid channel (181) that terminate at the nozzle (121) and fluid ejection chamber (122), and does not recirculate away from the nozzle (121) and fluid ejection chamber (122). In this example, the first fluid (150) is ejected as the second fluid (151) is consumed through the formation of the drive bubble (FIG. 4, 401).

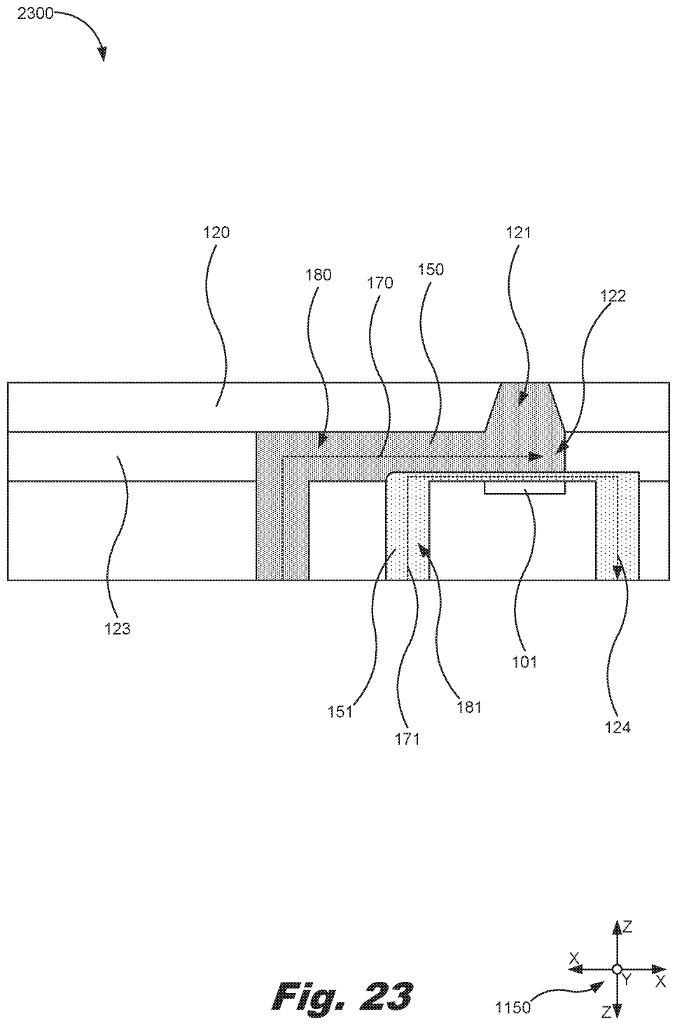

FIG. 23 is a side, cutaway view of a block diagram of a fluidic device (2300), according to an example of the principles described herein. The example of FIG. 23 includes those elements described in connection with the examples of FIGS. 1 through 22 and elsewhere herein, and may also include a first fluid channel (180) that terminates at the nozzle (121) and fluid ejection chamber (122), and does not recirculate away from the nozzle (121) and fluid ejection chamber (122). The example of FIG. 23 also includes a second fluid channel (181) that is circulated or recirculated away from the fluid ejection chamber (122) to form the laminar flow between the first fluid (150) and the actuator (101).

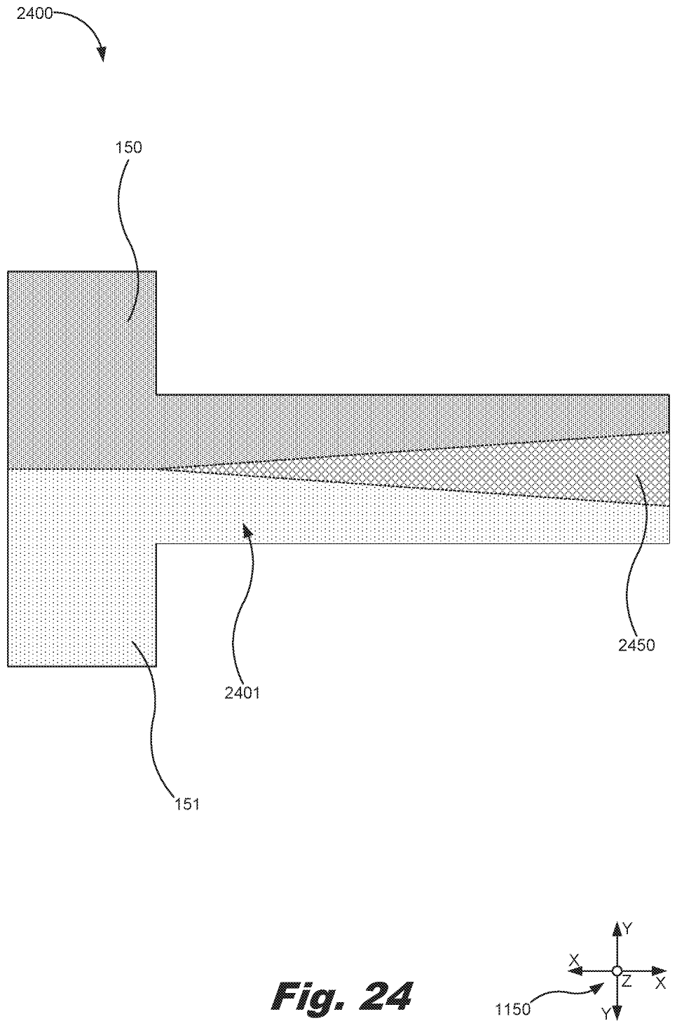

FIG. 24 is a top, cutaway view of a block diagram of a fluidic device (2400), according to an example of the principles described herein. The example of FIG. 24 describes a laminar flow of the two fluids (150, 151) within a system that are allowed to mix along a fluid channel (2401) to create a mixed fluid (2450). The rate at which the first fluid (150) and the second fluid (151) are caused to flow into the fluid channel (2401) determines the position within the fluid channel (2401) at which the fluids (150, 151) are mixed, and the concentration of the fluids (150, 151) within the mixed fluid (2450).

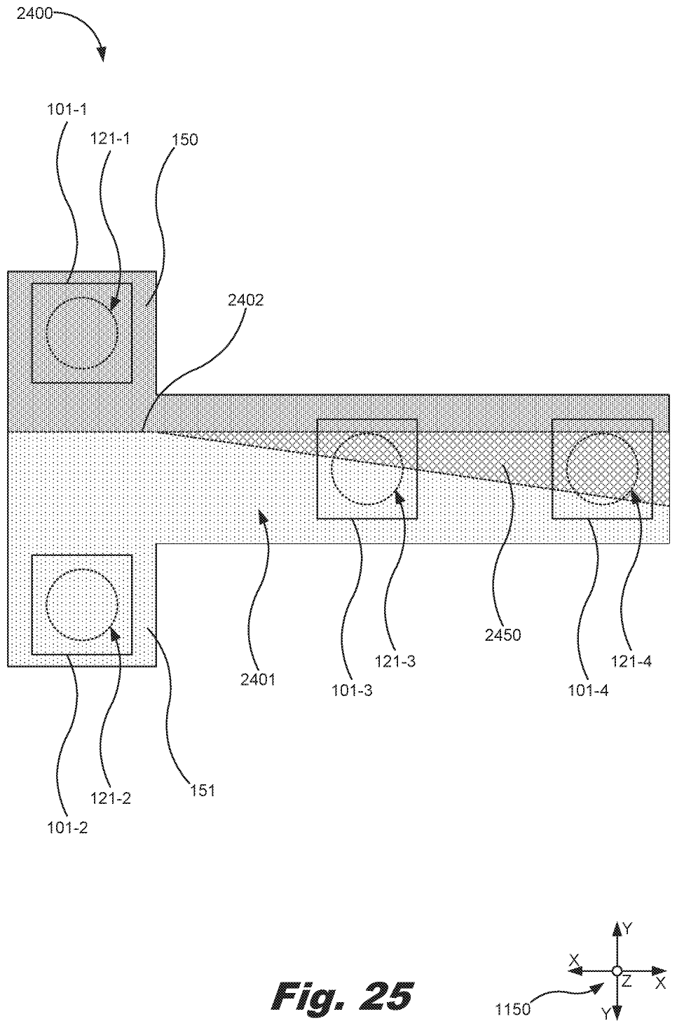

FIG. 25 is a top, cutaway view of a block diagram of a fluidic device (2400), according to an example of the principles described herein. FIG. 25 depicts the fluidic device (2400) of FIG. 24 and includes a plurality of actuators (101) and associated nozzles (121). The example of FIG. 25 also depicts an instance in which the second fluid (151) has a higher flow rate than the first fluid (150) which causes the boundary (between the first fluid (150) and the second fluid (151) to move in the y-direction towards the first fluid (150). In this example, the mixed fluid (2450) includes less of the first fluid (150) relative to the amount of the second fluid (151). Further, the dispersion of the mixed fluid (2450) is not symmetrical within the fluidic channel (2401). The laminar flow of FIGS. 24 and 25, includes no cross-stream velocity, which, in turn, slows mixing by minimizing the contacting surface area. As the flow proceeds down the fluid channel (2401) to the right of FIGS. 24 and 25, mixing of the fluids (150, 151) orthogonal to the flow direction is driven by diffusion. Some of the first fluid (150) will mix into the second fluid (151), and vice versa. The slope of interaction is a function of the diffusion properties of the two fluids (150, 151) and the flow rates thereof. Thus, it is possible to mix the fluids (150, 151) to form the mixed fluid (2450) at controlled ratios depending upon how far down the fluid channel (2450) the fluids (150, 151) (or a mixture thereof) are sampled.

The actuators (101) and associated nozzles (121) may be placed along the fluidic channel (2401) to allow for the sampling of different levels of the first fluid (150), the second fluid (151), and varying degrees of a mixture thereof by sampling amounts of the mixed fluid (2450), the first fluid (150), the second fluid (151), and combinations thereof. For example, the first actuator (101-1), if actuated, would eject 100% of the first fluid (150) from its associated nozzle (121-1). Likewise, the second actuator (101-2), if actuated, would eject 100% of the second fluid (151) from its associated nozzle (121-2). However, fluid ejected from the third nozzle (121-3) through activation of the third actuator (101-3) would include portions of the second fluid (151) and a mixture of the first fluid (150) and the second fluid (151). Fluid ejected from the fourth nozzle (121-4) through activation of the fourth actuator (101-4) would include a relatively larger amount of mixed fluid (2450) with respect to the third actuator (101-3) and nozzle (121-3). Thus, adding actuators (101) and nozzles (121) the example of FIG. 24 enables the ability to alter the ratio of the two fluids (150, 151) ejected. Further, in one example, the first fluid (150) and the second fluid (151) may include a reagent/analyte pair. In this example, the reaction may be sampled at various stages of development. using the positioning of the actuators (101) and nozzles (121). In another example where the first fluid (150) and the second fluid (121) are two colors of an ink, then various combinations of ink colors may be ejected from the nozzles (121) where the combinations differ in hue, for example.

Further, by controlling the flow rate of the two fluids (150, 151) relative to one another, the relative amounts of each fluid at a given position may be altered. For example, at the location of the third actuator (101-3), if a drop of fluid is ejected, the resultant fluid would include mostly the second fluid (151). In contrast, if the flow rate of the first fluid (150) is increased, a proportionate amount of the first fluid (150) will be ejected. The flow rates may be controlled using external pumps, thermal inkjet inertial pumps, other types of pumps, or combinations thereof.

In examples there the fluidic devices (2400) of FIGS. 24 and 25 are used to print, for example, inks, onto a print medium, the mixing fluid may be a colorless vehicle. In this example, multiple ink SKUs may be eliminated from the system. For example, the system may go from a seven-ink system that provides black (K), cyan (C), magenta (M), yellow (Y), a second black (k), a second cyan (c), and a second magenta (m) may be shifted to a system that utilizes five inks including KCMY plus the vehicle. In examples where the fluidic device (2400) is used as a microfluidic device such as in a lab-on-chip scenario, reactions may be sampled at various completion states by jetting a drop out of the fluidic device (2400) at various points along the fluid channel (2401).

The specification and figures describe a fluidic device. The fluidic device may include a at least one actuator, and fluid flow architecture to flow a first fluid through at least one fluidic channel, and flow a second fluid through the at least one fluidic channel to form a laminar flow between the first fluid and the actuator. The at least one actuator forms a drive bubble from the second fluid to cause the first fluid to be ejected from the fluidic die. The fluidic devices and the associated systems and methods described herein allow for the use of separate drive fluids that provide for a system with a greater fluid flexibility and that protect actuators from contamination or damage that may occur through the interaction of a fluid therewith.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluidic die comprising:
at least one actuator; and
fluid flow architecture to:
flow a first fluid through at least one fluidic channel; and
flow a second fluid through the at least one fluidic channel to form a laminar flow between the first fluid and the actuator,
wherein the at least one actuator forms a drive bubble from the second fluid to cause the first fluid to be ejected from the fluidic die.

2. The fluidic die of claim 1, wherein the second fluid is different from the first fluid.

3. The fluidic die of claim 2, wherein the first fluid and the second fluid are non-aqueous and aqueous respectively, aqueous and non-aqueous respectively, both aqueous, both non-aqueous, a non-polar solvent and a polar solvent respectively, a polar solvent and non-polar solvent respectively, miscible, immiscible, a suspension, an emulsion, or combinations thereof.

4. The fluidic die of claim 1, comprising a pump to cause the flow rate of the first fluid to be greater than the flow rate of the second fluid.

5. The fluidic die of claim 1, wherein the at least one fluidic channel comprises:
a first fluidic channel in which the first fluid flows; and
a second fluidic channel in which the second fluid flows,
wherein a cross-sectional area of the second fluidic channel is narrower than a cross-sectional area of the first fluidic channel.

6. The fluidic die of claim 5, comprising:
at least one permeable flow separator between the first fluidic channel and the second fluidic channel, at least one opening in the permeable flow separator comprising a cross-sectional area that is narrower than the first fluidic channel and the second fluidic channel,
wherein the at least one permeable flow separator reduces mixing between the first fluid and the second fluid.

7. The fluidic die of claim 1, wherein the at least one fluidic channel comprises:
a first fluidic channel in which the first fluid flows, the first fluidic channel comprising a first nozzle defined therein; and
a second fluidic channel in which the second fluid flows, the second fluidic channel comprising a second nozzle defined therein and fluidically coupled to the first fluidic channel.

8. The fluidic die of claim 1, wherein the at least one actuator is off-axis relative to a center of a nozzle from which the first fluid is ejected.

9. A dual-fluid ejection system, comprising:
fluid flow architecture to:
flow a first fluid through at least one fluidic channel; and
flow a second fluid through the at least one fluidic channel to form a laminar flow between the first fluid and an actuator
a first pump to cause the first fluid to flow in a first portion of the ejection system; and
a second pump to cause the second fluid to flow in a second portion of the ejection system.

10. The ejection system of claim 9, wherein the actuator comprises at least one actuator,
wherein the position of the at least one actuator within the ejection system defines a level of mixture of the first fluid and the second fluid.

11. The ejection system of claim 9, wherein the second fluid balances the evaporative loss of volatile components of the first fluid, the second fluid is an activating agent with respect to the first fluid that changes at least one property of the first fluid, comprises an immiscible combination that is separated after removal from the ejection system, or combinations thereof.

12. A method of ejecting fluid from a fluidic die, comprising:
flowing a first fluid;
flowing a second fluid different from the first fluid between the first fluid and an actuator; and
activating the actuator to form a drive bubble from the second fluid to cause the first fluid to be ejected from the fluidic die.

13. The method of claim 12, wherein flowing the first fluid and the second fluid comprises flowing the second fluid in a laminar flow between the first fluid and the actuator.

14. The method of claim 12, comprising:
with a first pump, pumping the first fluid at a first flow rate; and
with a second pump, pumping the second fluid at a second flow rate,
wherein the first flow rate is greater than the second flow rate.

15. The method of claim 12, wherein activating the actuator to form a drive bubble from the second fluid to cause the first fluid to be ejected from the fluidic die comprises:
ejecting the second fluid through a first nozzle based on an actuation of the actuator; and
ejecting the first fluid through a second nozzle based on the drive bubble formed by the activation of the actuator.
